(19) United States
(12) Patent Application Publication
(10) Pub. No.: US 2005/0226118 A1
(43) Pub. Date: Oct. 13, 2005

(54) METHOD AND APPARATUS FOR MOVING AN OPTICAL PROCESSING UNIT IN AN OPTICAL DISC DRIVE

(76) Inventors: Ta-Lung HUANG, Taipei City (TW); Chi-Chao HUNG, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/907,444

(22) Filed: Apr. 1, 2005

(30) Foreign Application Priority Data
Apr. 8, 2004 (TW) 093109825

(51) Int. Cl. G11B 7/00

(52) U.S. Cl. 369/53.38

(57) ABSTRACT

A method and related apparatus used for moving an optical processing unit (OPU) of an optical disc drive toward an initial position before the optical disc drive accesses optical disc data is disclosed. The method includes: providing a driving force to drive the OPU; determining whether or not the OPU starts to move; and increasing the driving force if the OPU does not move yet. Further, once the OPU is moving, speed control is maintained through use of a controller and a detecting device.

### BACKGROUND OF INVENTION

1. Field of the Invention

The present invention relates to an optical disc drive, and more particularly, to a method and apparatus for moving an optical processing unit in an optical disc drive before accessing an optical disc.

2. Description of the Prior Art

With the rapid developments of information technologies and the electronic industry, many consumer electronics have become smaller, lighter and more portable. This has resulted in users conveniently enjoying information technologies anytime and anywhere. In order to make the electronic products useable in an increased number of user mobile situations including walking, running, driving, or riding, one important design consideration is making the electronic products operable in a variety of physical positions.

Please refer to FIG. 1, which depicts a simplified schematic diagram of a conventional portable optical disc drive 100. The portable optical disc drive 100 comprises a spindle motor 110 for rotating an optical disc; an optical processing unit (OPU) 120 for reading data from the optical disc; and a sled motor 130 for driving the OPU 120 to slide along a sliding track 140. The OPU 120 utilizes a pick-up head 150 to access data. To reduce cost in the prior art, the sled motor 130 is typically implemented with a DC motor. FIG. 2 depicts a schematic diagram of the portable optical disc drive 100 rotated 180 degrees compared to FIG. 1.

When the portable optical disc drive 100 is turned off, the position of the OPU 120 may be changed with the motion of the user or the manner that portable optical disc drive 100 is set or placed. Since the actual position of the OPU 120 is unknown, the portable optical disc drive 100 forces the OPU 120 to return to an initial position before reading an optical disc. In conventional art, regardless the displacement of the portable optical disc drive 100, the sled motor 130 provides a first fixed force to drive the OPU 120 to slide inward until the OPU 120 reaches a limit device (not shown) near the spindle motor 110. Afterward, the sled motor 130 then provides an inverse second fixed force within a constant period to drive the OPU 120 to slide outward to an initial position of the optical disc in order to perform a track-seeking procedure.

As mentioned above, the conventional sled motor 130 uses fixed force to drive the OPU 120, so that the moving velocity of the OPU 120 is uniformly accelerated. Accordingly, the further the OPU 120 is from the spindle motor 110, the greater the impact of the OPU 120 will be against the limit device. Moreover, the influence caused by gravity is ignored in the prior art. For example, gravity slows down the motion of the OPU 120 in the position shown in FIG. 1, but speeds up the motion of the OPU 120 in the position shown in FIG. 2. Therefore, when gravity is beneficial for the OPU 120 to slide inward (such as under the displacement of FIG. 2), the conventional homing procedure of the OPU 120 may greatly increase the impact of the OPU 120 against the limit device and thereby induce unfavorable noise. Furthermore, the lifespan of the OPU 120 is accordingly reduced.

On the other hand, after the OPU 120 touches the limit device in the prior art, since the sled motor 130 then provides the second fixed force within a constant period to drive the OPU 120 to slide outward, the moving distance of the OPU 120 may also be affected by gravity. The effect in this instance may cause final position of the OPU 120 to differ from the initial position of the optical disc. In this situation, the required time for the portable optical disc drive 100 to perform track-seeking procedure is increased and the access performance is thereby affected.

### SUMMARY OF INVENTION

It is therefore an objective of the claimed invention to provide a method for moving an optical processing unit (OPU) in an optical disc drive to solve the above-mentioned problem by controlling the moving speed of the OPU using feedback control manner.

According to a preferred embodiment, the method used for moving the OPU toward an initial position in the optical disc drive before the optical disc drive accesses an optical disc. The method comprises providing a driving force to drive the OPU; determining whether the OPU starts moving or not; and increasing the driving force if the OPU does not move yet.

Another objective of the present invention to provide a sled actuator in an optical disc drive for moving an optical processing unit (OPU) of the optical disc drive toward an initial position before the optical disc drive accesses an optical disc. The sled actuator comprises: a sled motor for providing a driving force to drive the OPU; a detecting device electrically connected to the sled motor for detecting the moment of the OPU to generate a corresponding detection signal; and a control circuit electrically connected to the sled motor and the detecting device for controlling the sled motor to adjust the driving force according to the detection signal.

One advantage of the present invention is that the OPU can slide in a feasible constant velocity to reduce the impact and noise of the OPU against other components, and the lifespan of components of the optical disc drive are thereby extended.

Another advantage of the present invention is that the OPU will slide to the initial position of the optical disc accurately to reduce the required time for accessing data.

Yet another advantage of the present invention is that the sled motor of the sled actuator can be implemented with a DC motor to reduce cost.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a conventional portable optical disc drive.

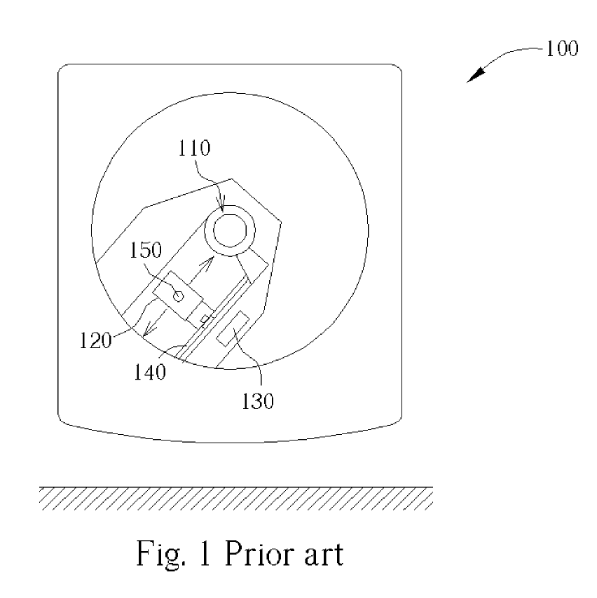

FIG. 2 is a schematic diagrams of the conventional portable optical disc drive of FIG. 1, with its position rotated 180 degrees.

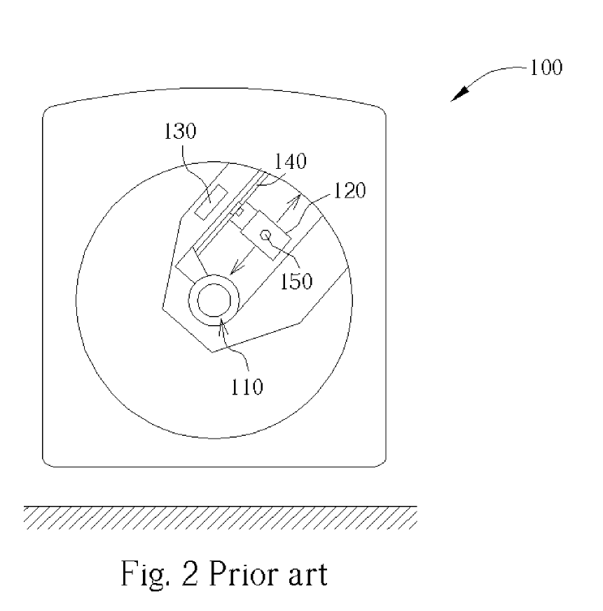

FIG. 3 is a schematic diagram of an optical disc drive according to the present invention.

FIG. 4 is a schematic diagram of an embodiment of a sled actuator of the optical disc drive of FIG. 3.

FIG. 5 is a flowchart describing the steps to drive an OPU of the optical disc drive of FIG. 3 to slide to the innermost position along a sliding track using the sled actuator shown in FIG. 4.

FIG. 6 is a plot of detection signals generated by a detecting device of the sled actuator of FIG. 4.

FIG. 7 is a flowchart describing the steps to drive the OPU of the optical disc drive of FIG. 3 to slide outward to the initial position of the optical disc using the sled actuator of FIG. 4.

### DETAILED DESCRIPTION

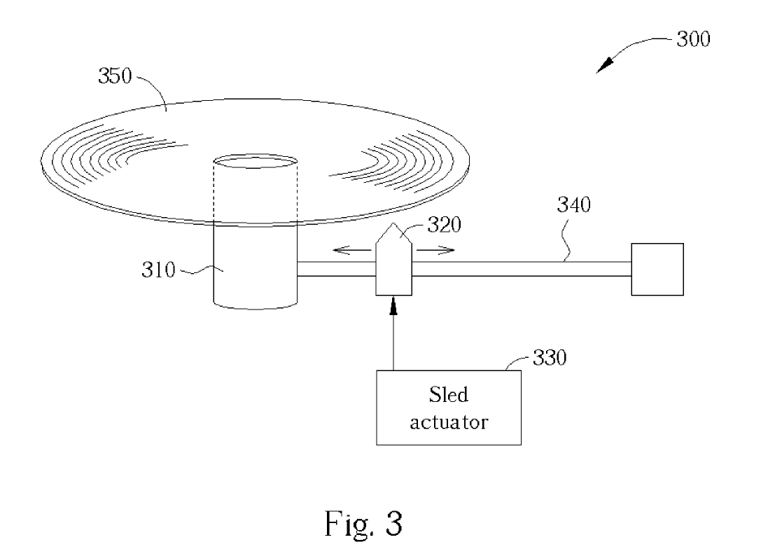

Please refer to FIG. 3, which depicts a simplified schematic diagram of an optical disc drive 300 according to the present invention. The optical disc drive 300 comprises a spindle motor 310 for rotating an optical disc 350; an optical processing unit (OPU) 320 for accessing the optical disc 350; and a sled actuator 330 for driving the OPU 320 to slide along a sliding track 340. In practical implementations, the optical disc drive 300 of the present invention can be any kind of portable CD/DVD player or recorder.

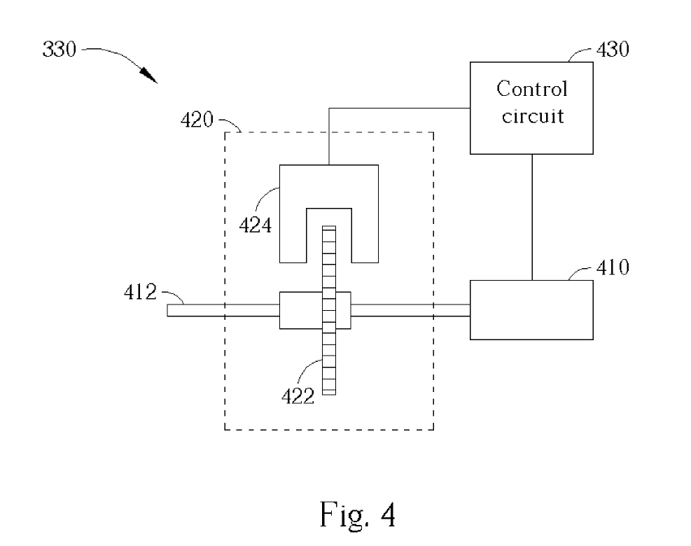

FIG. 4 depicts a schematic diagram of one embodiment of the sled actuator 330 of FIG. 3. The sled actuator 330 comprises a sled motor 410 for proving a driving force to drive the OPU 320; a detecting device 420 electrically connected to the sled motor 410 for detecting the moment of the OPU to generate a corresponding detection signal; and a control circuit 430 electrically connected to the sled motor 410 and the detecting device 420, the control circuit 430 for controlling the sled motor to adjust the driving force according to the detection signal in order to maintain the moving speed of the OPU 320 within a predetermined range. In a preferred embodiment, the sled motor 410 can be implemented with a DC motor to reduce cost, and the control circuit 430 can be the microprocessor of the optical disc drive 300.

The detecting device 420 of the sled actuator 330 further includes a gear wheel 422 installed on a shaft 412 of the sled motor 410; and a photo interrupter module 424 for detecting the rotation of the gear wheel 422. When the sled motor 410 operates, its shaft 412 drives the OPU 320 through a transmission mechanism and also rotates the gear wheel 422. As is well known in the art, a gear combination, a belt, a sawtooth bar, or the like can be implemented as the transmission mechanism, and as such further details are omitted here.

As mentioned above, before the optical disc drive 300 starts to access the optical disc 350, the sled actuator 330 moves the OPU 320 to a proper position so that a pick-up head (not shown) of the OPU 320 can perform the track-seeking operation. The above movement can be separated into two stages. In the first stage, the OPU 320 is moved along the sliding track 340 from any position to the innermost position, where the OPU 320 touches a limit device near the spindle motor 310. In the second stage, the OPU 320 is moved outward to an initial position of the optical disc 350. The operations of the sled actuator 330 in above two stages are described with flowcharts in following.

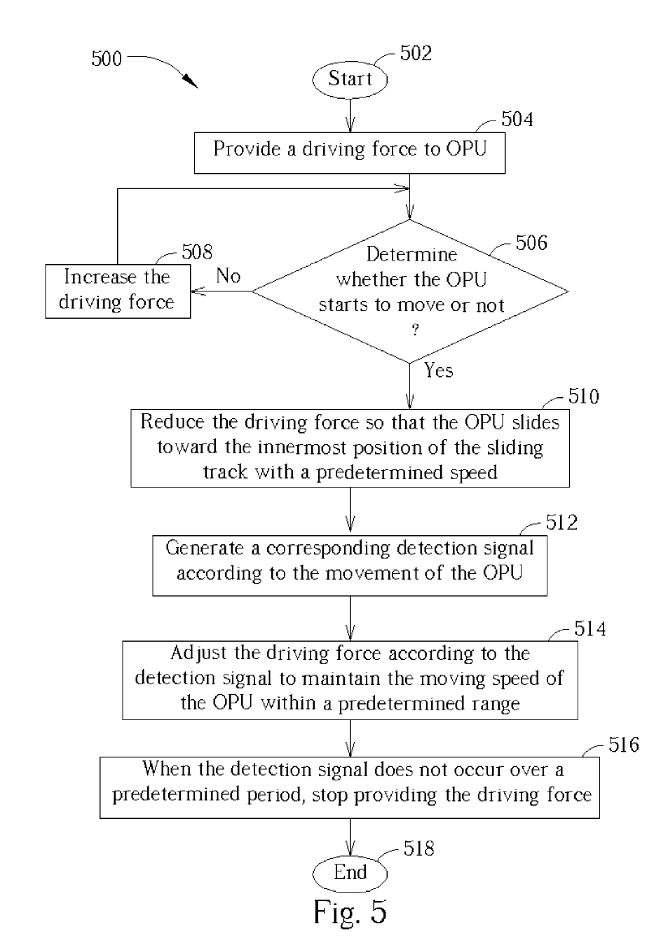

Please refer to FIG. 5, which depicts a flowchart of how the sled actuator 330 drives the OPU 320 to slide to the innermost position along the sliding track 340 according to the present invention. The flowchart includes following steps:

Step 502: Start.

Step 504: Provide a driving force F1 to the OPU 320.

Step 506: Determine whether the OPU 320 starts moving. If the OPU 320 moves, perform step 510, otherwise, perform step 508.

Step 508: Increase the driving force F1.

Step 510: Reduce the driving force F1 so that the OPU 320 slides toward the innermost position of the sliding track 340 with a predetermined speed.

Step 512: Generate a corresponding detection signal according to the movement of the OPU 320.

Step 514: Adjust the driving force F1 according to the detection signal to maintain the moving speed of the OPU 320 within a predetermined range.

Step 516: When the detection signal does not occur over a predetermined period, stop providing the driving force F1.

Step 518: End.

Since the OPU 320 is static at the beginning, the sled motor 410 provides the driving force F1 to the OPU 320 in step 504.

In the following step 506, the control circuit 430 determines whether or not the OPU 320 starts to move. If the OPU 320 does not move, it means the driving force F1 provided by the sled motor 410 can not overcome the force of static friction (possibly made worse due to the gravity effect) of the OPU 320. Therefore, the control circuit 430 controls the sled motor 410 to progressively increase the driving force F1 to drive the OPU 320 to move.

While the OPU 320 slides, the driving force needed to drive the OPU 320 can be reduced. Therefore, the sled motor 410 reduces the driving force F1 in step 510, so that the OPU 320 slides toward the innermost position of the sliding track 340 at a proper predetermined speed.

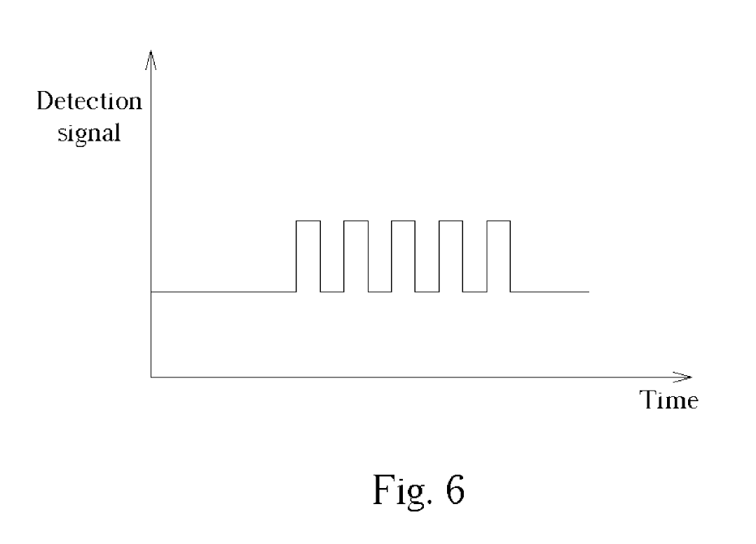

In steps 512 and 514, the sled actuator 330 of the present invention constantly adjusts the driving force F1 based on the movement situation of the OPU 320 to maintain the moving speed of the OPU 320 within the predetermined range. For example, in the embodiment shown in FIG. 4, when the OPU 320 moves, it means that the shaft 412 of the sled motor 410 is rotated, and the gear wheel 422 is also rotated. Therefore, in step 512, when the sawtooth edges of the gear wheel 422 pass the groove of the photo interrupter module 424, the photo interrupter module 424 generates a corresponding detection signal according to the detected ruminate change as shown in FIG. 6. In a preferred embodiment, the number of pulses of the detection signal in FIG. 6 corresponds to the number of rotated teeth of the gear wheel 422. Accordingly, it is known that the number of the pulses of the detection signal also corresponds to the moved distance of the OPU 320. In other words, the photo interrupter module 424 can detect the movement of the OPU 320 according to the rotation of the gear wheel 422 in step 512.

Next, in step 514, the control circuit 430 of the sled actuator 330 converts the number of pulses of the detection signal generated within a unit period to the moving speed of the OPU 320. In addition, the control circuit 430 adjusts the driving force F1 provided by the sled motor 410 according to the calculated moving speed to maintain the moving speed of the OPU 320 within the predetermined range. In practical implementations, the control circuit 430 can adjust the magnitude of the driving force F1 by adjusting the input voltage of the sled motor 410.

The OPU 320 cannot slide further forward when it arrives at the innermost position of the sliding track 340, where the OPU 320 contacts the limit device near the spindle motor 310. At this moment, both the shaft 412 and the gear wheel 422 stop rotating, such that the pulses of the detection signal stop occurring. Accordingly, in step 516, if the photo interrupter module 424 does not generate any detection signal over a predetermined period, the control circuit 430 determines that the OPU 320 has contacted with the limit device, and the control circuit 430 controls the sled motor 410 to stop providing the driving force F1.

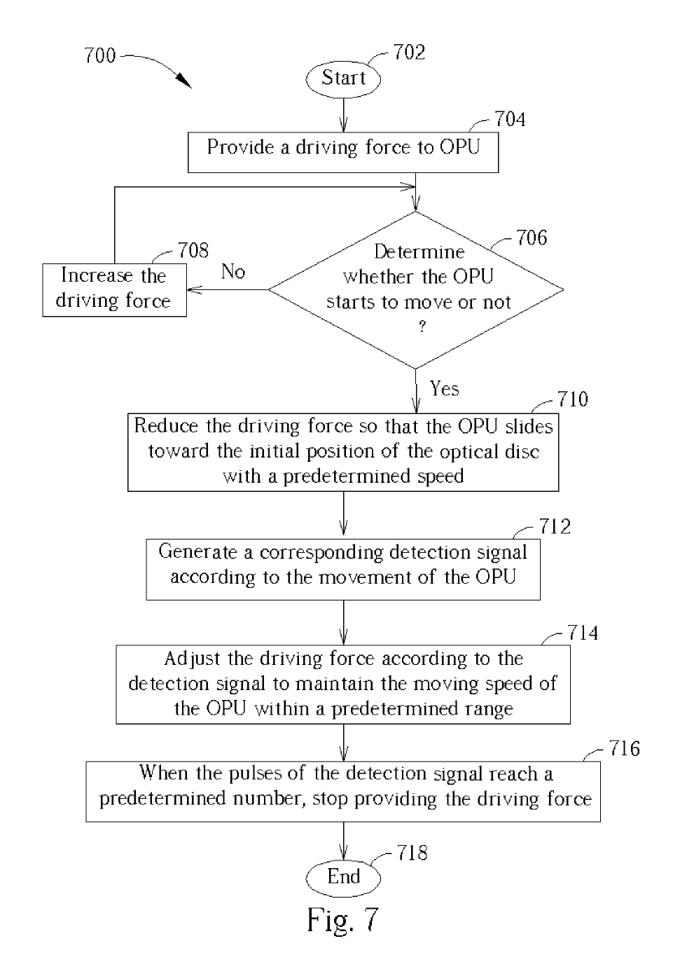

Next refer to FIG. 7, which depicts a flowchart showing how the sled actuator 330 drives the OPU 320 to slide outward to an initial position of the optical disc 350 according to the present invention. The flowchart comprises following steps:

Step 702: Start.

Step 704: Provide a driving force F2 to the OPU 320.

Step 706: Determine whether the OPU 320 starts moving or not. If the OPU 320 moves, perform step 710, otherwise, perform step 708.

Step 708: Increase the driving force F2.

Step 710: Reduce the driving force F2 so that the OPU 320 slides toward the initial position of the optical disc 350 with a predetermined speed.

Step 712: Generate a corresponding detection signal according to the movement of the OPU 320.

Step 714: Adjust the driving force F2 according to the detection signal to maintain the moving speed of the OPU 320 within a predetermined range.

Step 716: When the pulses of the detection signal reach a predetermined number, stop providing the driving force F2.

Step 718: End.

The steps 704 through 714 are substantially the same with foregoing steps 504 through 514. The only difference is that the moving directions of the OPU 320 are opposite, and the further details are omitted for brevity.

As mentioned above, the number of rotated teethes of the gear wheel 422 corresponds to the moving distance of the OPU 320. Thus, in step 716, when the pulses of the detection signal generated from the photo interrupter module 424 reach to a predetermined number, it means that the OPU 320 has moved outward a specific distance from the innermost position of the sliding track 340. Accordingly, the control circuit 430 determines that the OPU 320 has arrived to the initial position of the optical disc 350, so that the control circuit 430 controls the sled motor 410 stop providing the driving force F2. In practice, the predetermined number relates to the diameter of the gear wheel 422 and the distance between teeth thereof, and not limited to a specific number.

As mentioned, while the sled actuator 330 of the present invention moves the OPU 320, the control circuit 430 adjusts the output force of the sled motor 410 according to the detection signal generated from the sled motor 410 to maintain the moving speed of the OPU 320 within a predetermined range. As a result, the impact and noise of the OPU 320 against the limit device are greatly reduced and lifespan of components are thereby extended. In addition, the sled actuator 330 can accurately move the OPU 320 to the initial position of the optical disc 350 to speed up following track-seeking procedures in accordance with the number of pulses of the detection signal generated by the detecting device 420. Furthermore, the sled motor 410 of the sled actuator 330 can be implemented with a DC motor to reduce cost and increase the competency of the products.

Those skilled in the art will readily observe that numerous modifications and alterations of the device may be made while retaining the teachings of the invention. Accordingly, the above disclosure should be construed as limited only by the metes and bounds of the appended claims.

1. A method for moving an optical processing unit (OPU) of an optical disc drive toward an initial position before the optical disc drive accesses an optical disc, the method comprising:
(a) providing a driving force to drive the OPU;
(b) determining whether or not the OPU starts to move; and
(c) increasing the driving force if the OPU does not move yet.

2. The method of claim 1, further comprising:
(d) if the OPU starts to move, adjusting the driving force so that the OPU is moved with a predetermined speed.

3. The method of claim 2, further comprising:
generating a detection signal according to the moment of the OPU; and
adjusting the driving force according to the detection signal in order to maintain the moving speed of the OPU within a predetermined range.

4. The method of claim 3, wherein the optical disc drive further comprises a motor and step (a) further comprises controlling the motor to generate the driving force.

5. The method of claim 4, further comprising:
detecting the movement of the OPU according to the rotation of the shaft of the motor.

6. The method of claim 4, wherein the detection signal corresponds to the rotation number of the shaft of the motor.

7. The method of claim 4, wherein the detection signal corresponds to the rotation speed of shaft of the motor.

8. The method of claim 4, further comprising:
if the OPU does not move over a predetermined period, stopping the driving force.

9. The method of claim 4, further comprising:
when the pulse number of the detection signal reaches a predetermined value, stopping the driving force.

10. The method of claim 4, wherein the motor is not a stepping motor.

11. A sled actuator in an optical disc drive for moving an optical processing unit (OPU) of the optical disc drive toward an initial position before the optical disc drive accesses an optical disc, the sled actuator comprising:
a sled motor for providing a driving force to drive the OPU;
a detecting device electrically connected to the sled motor, the detecting device for detecting the moment of the OPU to generate a detection signal; and
a control circuit electrically connected to the sled motor and the detecting device, the control circuit for controlling the sled motor to adjust the driving force according to the detection signal.

12. The sled actuator of claim 11, wherein the sled motor is not a stepping motor.

13. The sled actuator of claim 11, wherein the detecting device comprises:
a photo interrupter module for detecting the rotation of the shaft of the sled motor to generate the detection signal;
wherein the rotation of the shaft of the sled motor corresponds to the moment of the OPU.

14. The sled actuator of claim 13, wherein the detection signal corresponds to the rotation number of the shaft of the sled motor.

15. The sled actuator of claim 13, wherein the detection signal corresponds to the rotation speed of the shaft of the sled motor.

16. The sled actuator of claim 13, wherein if the OPU does not move over a predetermined period, the control circuit controls the sled motor to stop providing the driving force.

17. The sled actuator of claim 13, wherein when the pulse number of the detection signal reaches a predetermined value, the control circuit controls the sled motor to stop providing the driving force.

18. The sled actuator of claim 11, wherein the control circuit controls the sled motor to adjust the driving force according to the detection signal in order to maintain the moving speed of the OPU within a predetermined range.

19. The sled actuator of claim 11, wherein the sled motor is a DC motor.
